(19) United States
(12) Patent Application Publication
(10) Pub. No.: US 2013/0041821 A1
(43) Pub. Date: Feb. 14, 2013

(54) FRAUD MESSAGING SERVICE

(71) Applicants: Tamara S. Kingston, Peoria, AZ (US); Elbert Lee Whitler, Webster Groves, MO (US); John Franklin Tuders, Harrisburg, NC (US); Willard Andrew Barr, Charlotte, NC (US)

(72) Inventors: Tamara S. Kingston, Peoria, AZ (US); Elbert Lee Whitler, Webster Groves, MO (US); John Franklin Tuders, Harrisburg, NC (US); Willard Andrew Barr, Charlotte, NC (US)

(73) Assignee: Bank of America Corporation, Charlotte, NC (US)

(21) Appl. No.: 13/207,025

(22) Filed: Aug. 10, 2011

(51) Int. Cl. G06Q 40/00

(52) U.S. Cl. 705/44

(57) ABSTRACT

In general terms, embodiments of the present invention relate to methods and apparatuses for providing a fraud messaging service. For example, in some embodiments, a method is provided that includes: (a) receiving transaction information associated with a transaction, where the transaction involves an account, and where the account is held by an account holder; (b) determining, based at least partially on the transaction information, that the transaction has triggered a fraud rule; (c) prompting, via a mobile device, the holder to consent to the transaction, where the mobile device is associated with the holder, and where the prompting the holder is based at least partially on the determining that the transaction has triggered the fraud rule; (d) receiving the holder's consent to the transaction; and (e) authorizing the transaction based at least partially on the receiving the holder's consent.

### BACKGROUND

To avoid costs to financial institutions and their customers in the amounts of billions of dollars each year, financial institutions maintain a system that identifies misappropriation of identification. Financial institutions use various identification methods to maintain good standing with its customers. In order to have the ability to provide safe and reliable financial services, there is a need for new ways to reduce or prevent financial transactions involving misappropriation.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for providing a fraud messaging service. As a specific example, an account holder may use his account to engage in a legitimate transaction with a merchant. However, the holder's financial institution may determine that the transaction may involve misappropriation because, for example, the transaction amount is unusually high or the transaction is occurring at an unusual time. In such embodiments, as a result of making this determination and instead of immediately declining the transaction, the financial institution may send a message (e.g., fraud alert) to the holder's mobile device, where the message prompts the holder to consent to the transaction. If the holder consents within a predetermined period of time, the financial institution will authorize the transaction so that the transaction can be completed.

On the other hand, if the transaction has not been authorized by the holder (e.g., where a dishonest person has initiated the transaction), the holder may respond to the message received at his mobile device by indicating that he does not consent to the transaction. In such embodiments, if the financial institution receives this response from the holder, or if the financial institution does not receive any response from the holder within a predetermined period of time, the financial institution can decline the transaction and/or otherwise prevent the transaction from being completed.

Accordingly, embodiments of the present invention enable financial institutions and their account holders to work together to verify potentially transactions that involve misappropriation before those transactions are authorized and/or completed. This achieves at least two important objectives. First, this cooperation may help reduce the total number of transactions that involve misappropriation are authorized by the financial institution. In addition, this cooperation may help reduce the total number of legitimate transactions that are declined for reasons of fraud.

It will be understood that embodiments of the present invention provide mechanisms for verifying that the person engaging in the transaction and/or consenting to the transaction is actually the true account holder. First, as previously discussed, some embodiments require the financial institution to prompt the holder to consent to the transaction via the holder's mobile device (e.g., a mobile phone owned by the holder, controlled by the holder, accessible to the holder, etc.). However, in other embodiments, the financial institution may prompt the holder to consent to the transaction via a merchant's point-of-sale (POS) device, but the holder may still provide his consent to the transaction using his mobile device. Either way, because the holder's mobile device is used at some point in the process, the financial institution can be reasonably sure that the holder—and not some unauthorized user—is the one actually engaging in the transaction and/or consenting to the transaction.

Another verification mechanism involves a fraud passcode. In some embodiments, the fraud passcode is a secret personal identification number (PIN) that is known only to the holder and his financial institution. In some of these embodiments, the fraud passcode is different than a primary passcode (e.g., primary PIN) used, for example, to engage in conventional debit card transactions at a merchant's POS device. Thus, if the financial institution determines that a transaction involving the holder's account may involve misappropriation, the financial institution can prompt the holder to provide the fraud passcode if the holder wishes to consent to the transaction. If the holder provides his fraud passcode within a predetermined period of time, the financial institution can authorize the transaction and/or otherwise enable the transaction to be completed. In such embodiments, the financial institution can be reasonably sure that the person engaging in the transaction and/or consenting to the transaction is actually the holder if that person provides the holder's fraud passcode.

In more general terms, some embodiments of the present invention provide a method that includes: (a) receiving transaction information associated with a transaction, where the transaction involves an account, and where the account is held by an account holder; (b) determining, based at least partially on the transaction information, that the transaction has triggered a fraud rule; (c) prompting, via a mobile device, the holder to consent to the transaction, where the mobile device is associated with the holder, and where the prompting the holder is based at least partially on the determining that the transaction has triggered the fraud rule; (d) receiving the holder's consent to the transaction; and (e) authorizing the transaction based at least partially on the receiving the holder's consent.

Other embodiments of the present invention provide an apparatus that includes a processing device configured to: (a) receive, via a payment network, transaction information associated with a transaction, where the transaction involves an account, and where the account is held by an account holder; (b) determine, based at least partially on the transaction information, that the transaction has triggered a fraud rule; (c) prompt, via a mobile device, the holder to consent to the transaction, where the mobile device is associated with the holder, and where the prompting is based at least partially on the determining; (d) receive the holder's consent to the transaction; (e) authorize the transaction based at least partially on the receiving the holder's consent.

Still other embodiments provide a computer program product having a non-transitory computer-readable medium, where the non-transitory computer-readable medium includes one or more computer-executable program code portions that, when executed by a computer, cause the computer to: (a) receive transaction information associated with a transaction, where the transaction involves an account, and where the account is held by an account holder; (b) determine that the transaction may involve misappropriation; (c) prompt, via a mobile device, the holder to consent to the transaction, where the mobile device is associated with the holder; (d) determine that the holder has not consented to the transaction within a predetermined period of time; and (e) decline the transaction based at least partially on the computer determining that the holder has not consented within the predetermined period of time.

In addition, some embodiments of the present invention provide another method that includes: (a) receiving transaction information associated with a transaction, where the transaction involves an account and a transaction machine, and where the account is held by an account holder; (b) determining, based at least partially on the transaction information, that the transaction has triggered a fraud rule; (c) prompting, via the transaction machine, the holder to consent to the transaction, where the prompting is based at least partially on the determining; (d) receiving the holder's consent to the transaction via a mobile device associated with the holder; and (e) authorizing the transaction based at least partially on the receiving the holder's consent via the mobile device associated with the holder.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for providing a fraud messaging service, in accordance with an embodiment of the present invention;

FIG. 2 is a flow diagram illustrating a more-detailed process flow for providing a fraud messaging service using a mobile device, in accordance with an embodiment of the present invention;

FIG. 3 is a block diagram illustrating technical components of a system for providing a fraud messaging service, in accordance with an embodiment of the present invention;

FIG. 3A is a block diagram illustrating technical components of a mobile device configured to participate in a fraud messaging service, in accordance with an embodiment of the present invention; and

FIG. 4 is a mixed block and flow diagram of a system for providing a fraud messaging service using a fraud passcode and a mobile phone, in accordance with an embodiment of the present invention.

### DETAILED DESCRIPTION OF EMBODIMENTS OF THE PRESENT INVENTION

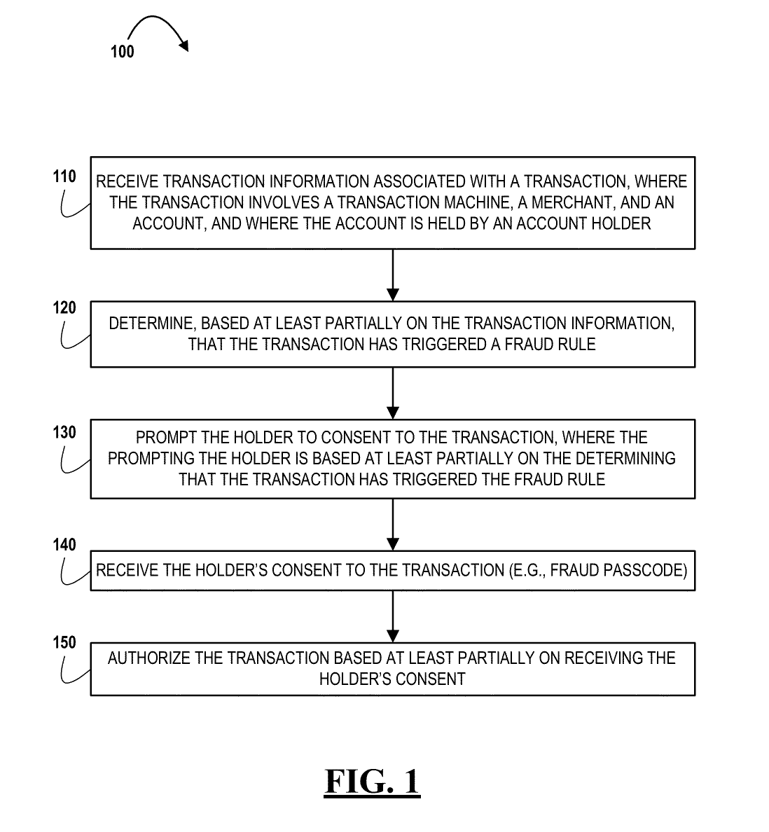

Referring now to FIG. 1, a general process flow 100 for providing a fraud messaging service is provided, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a transaction, where the transaction has a transaction amount, where the transaction involves a transaction machine (e.g., POS device, PC, mobile phone, etc.), a merchant (e.g., retailer, wholesaler, counterparty, etc.), and an account (e.g., a deposit account, a credit account, etc.), and where the account is held by an account holder. As represented by block 120, the apparatus is also configured to determine, based at least partially on the transaction information, that the transaction has triggered a fraud rule. In addition, as represented by block 130, the apparatus is further configured to prompt the holder to consent to the transaction, where the prompting the holder is based at least partially on the determining that the transaction has triggered the fraud rule. As represented by block 140, the apparatus is further configured to receive the holder's consent to the transaction (e.g., via a fraud passcode). As represented by block 150, the apparatus is further configured to authorize the transaction based at least partially on receiving the holder's consent.

For simplicity, it will be understood that the portion of the process flow represented by block 120 is sometimes referred to herein as the “fraud rule determination.” In addition, it will be understood that, in some embodiments, the term “determine” is meant to have one or more of its ordinary meanings (i.e., its ordinary dictionary definition(s)), but that in other embodiments, that term is meant to have one or more of the ordinary meanings of one or more of the following terms: decide, conclude, verify, ascertain, find, discover, learn, calculate, observe, read, and/or the like. Further, in some embodiments, the phrase “based at least partially on” is meant to have one or more of its ordinary meanings, but that in other embodiments, that phrase is meant to have one or more of the ordinary meanings of one or more of the following terms and/or phrases: as a result of, because of, after, if, when, in response to, and/or the like. Still further, in some embodiments, the term “via” is meant to have its one or more ordinary meanings, but in other embodiments, that term is meant to have one or more ordinary meanings of one or more of the following terms and/or phrases: through, per, with the assistance of, by way of, from, and/or the like.

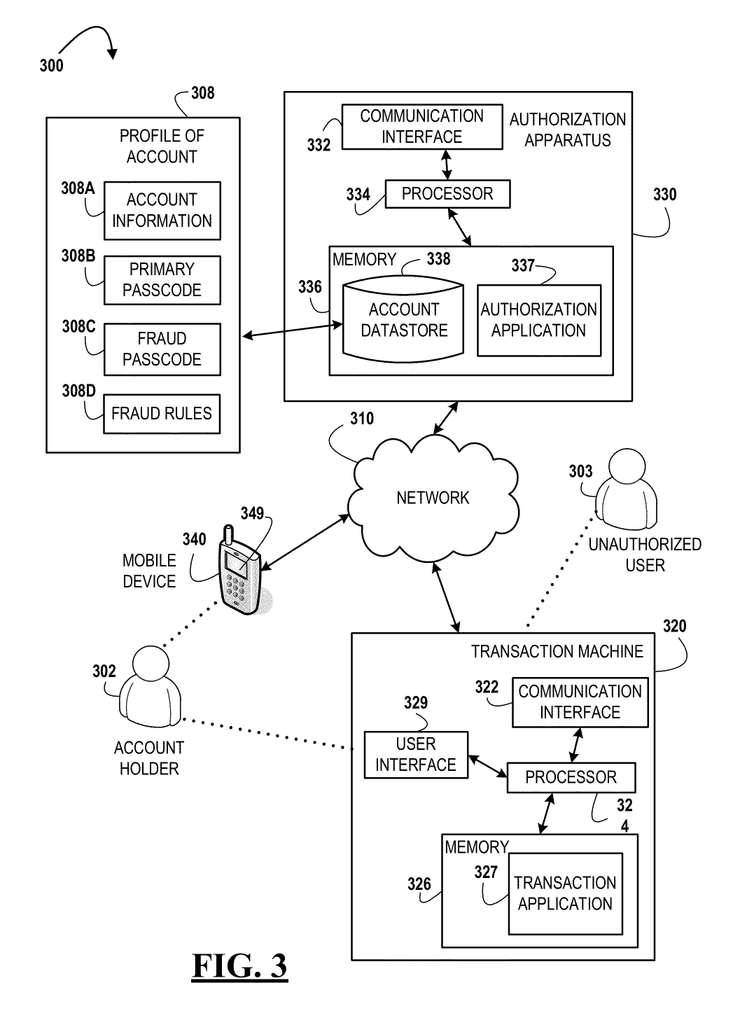

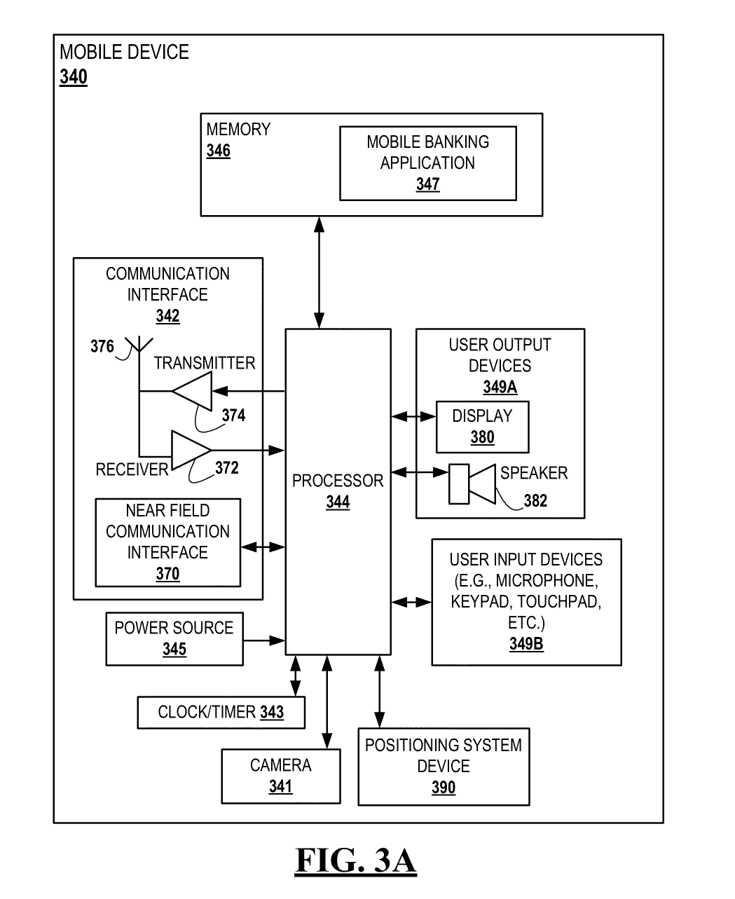

It will also be understood that the apparatus having the process flow 100 can include one or more separate and/or different apparatuses. For example, in some embodiments, one apparatus (e.g., the transaction machine 320 described in connection with FIG. 3, etc.) is configured to perform the portion of the process flow 100 represented by block 110, and a second apparatus (e.g., the authorization apparatus 330) is configured to perform the portions represented by blocks 120-150. As still another example, in some embodiments, a single apparatus (e.g., the authorization apparatus 330) is configured to perform each and every portion of the process flow 100. It will also be understood that, in some embodiments, a transaction machine (e.g., the transaction machine 320) is configured to perform one or more (or all) of the portions of the process flow 100, and that in some embodiments, that transaction machine includes, is included in, and/or is embodied as the transaction machine referred to in block 110.

Regarding block 110, the phrase “transaction machine,” as used herein, typically refers to an interactive computer terminal that is configured to initiate, perform, complete, and/or otherwise facilitate one or more financial transactions. Examples of transaction machines include, but are not limited to, automated teller machines (ATMs), POS devices (e.g., merchant terminals, etc.), self-service machines (e.g., vending machine, ATM, self-checkout machine, parking meter, etc.), public and/or business kiosks (e.g., an Internet kiosk, ticketing kiosk, bill pay kiosk, etc.), mobile phones (e.g., feature phone, smart phone, etc.), gaming devices, computers (e.g., personal computers, tablet computers, laptop computers, etc.), personal digital assistants (PDAs), and/or the like.

In some embodiments, the transaction machine referred to in block 110 is located in a public place and is available for public use (e.g., on a street corner, on the exterior wall of a banking center, at a public rest stop, etc.). In other embodiments, the transaction machine is additionally or alternatively located in a place of business and available for public and/or business customer use (e.g., in a retail store, post office, banking center, grocery store, etc.). In accordance with some embodiments, the transaction machine is not owned by the user of the transaction machine and/or by the holder of the account referred to in block 110. However, in other embodiments, the transaction machine is located in a private place, is available for private use, and/or is owned by the user of the transaction machine and/or by the holder.

Further regarding block 110, the transaction involving the holder and the transaction machine can include any number and/or type of transaction(s) involving a transaction machine. For example, in some embodiments, the transaction includes one or more of the following: purchasing, renting, selling, and/or leasing one or more goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards; donating to charities; and/or the like.

Also, the account referred to in the process flow 100 can include any number and/or type of account(s). For example, in some embodiments, the account is a deposit account, such as, for example, a checking account, savings account, money market account, investment account, brokerage account, certificate of deposit account, and/or the like. However, in other embodiments, the account referred to in block 110 is a credit account, such as, for example, a credit card account, line of credit (LOC) account, store credit account, and/or the like.

In some embodiments, the account, the transaction machine, and the apparatus having the process flow 100 are each controlled, serviced, owned, managed, operated, and/or maintained (collectively referred to herein as “maintained” for simplicity) by a single financial institution. For example, in some embodiments, the apparatus is maintained by a bank, the account is maintained by the bank, the transaction machine is owned by the bank, and the holder is a customer of the bank. In other embodiments, the apparatus, the transaction machine, and/or the account are not maintained by the same financial institution (or any financial institution).

The transaction information referred to in block 110 can be any information that identifies, defines, describes, and/or is otherwise associated with a transaction. Exemplary transaction information includes, but is not limited to, the party(ies) involved in the transaction, the date and/or time of the transaction, the location of the transaction, the account(s) involved in the transaction, the primary passcode (e.g., PIN) associated with the account, the transaction amount(s) associated with the transaction, the good(s) and/or service(s) involved in the transaction (e.g., product names, stock keeping unit (SKU) information, universal product code (UPC) information, etc.), the channel(s) (e.g., ATM, teller terminal, etc.) through which the transaction is conducted, a description of the transaction (which, itself, can include any transaction information, e.g., the description may describe the transaction status, the transaction amount, the merchant involved in the transaction, the goods and/or services involved in the transaction, etc.), and/or the like.

The transaction information can also include any information that defines and/or identifies the type of the transaction. As understood herein, the transaction type of a transaction may be defined, at least in part, by the one or more goods and/or services involved in the transaction, the one or more types of accounts involved in the transaction (e.g., credit card transaction, savings account transaction, etc.), the one or more parties involved in the transaction (e.g., account holder, bank, teller, merchant, counterparty, etc.), when the transaction was initiated (e.g., time of day, day of week, etc.), and/or the like. In some embodiments, the transaction type is defined, at least in part, by the one or more channels through which the transaction is conducted, such as, for example, a POS device (e.g., merchant terminal, etc.), ATM, teller terminal, electronic banking account (e.g., online banking account, mobile banking account, SMS banking account, etc.), personal computer, kiosk, call center, and/or the like. Additionally or alternatively, in some embodiments, the transaction type is defined, at least in part, by the one or more instruments and/or methods used to conduct the transaction, such as, for example, paper checks, electronic checks, debit cards, credit cards, ATM cards, checkcards, wire transfers, online bill pay, automated clearing house (ACH), contactless payments, near field communication (NFC) interface payments, cash payments, and/or the like.

In some embodiments, the transaction information additionally or alternatively identifies and/or describes one or more merchant category codes (MCCs) associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by well-known credit payment processors and/or some other credit card provider (which, in some embodiments, is a bank). Exemplary merchant category codes include “5814” for fast food restaurants, “5933” for pawn shops, “8062” for hospitals, “5411” for grocery supermarkets, and “3501” for a well-known hotel chain. A merchant category code may generally refer to the goods and/or services provided by a merchant (e.g., hospital, fast food restaurant, etc.) and/or may specifically identify the name of an individual merchant. In other words, individual industries and/or individual merchants can have their own merchant category codes. In some embodiments, a transaction type may be defined, at least in part, by one or more merchant category codes associated with the transaction.

It will be understood that any given transaction may have more than one transaction type. For example, in accordance with some embodiments, a cash withdrawal transaction conducted an ATM may be defined as a cash-related transaction, a withdrawal transaction, and/or an ATM transaction. As another example, in accordance with some embodiments, a purchase transaction involving a POS device and a mobile device, where each of the POS device and the mobile device has an NFC interface, may be defined as a purchase transaction, a POS device transaction, mobile device transaction, an NFC interface transaction, and/or a contactless payment transaction. As still another example, in accordance with some embodiments, a purchase transaction involving a POS device maintained by a grocery store may be defined as a purchase transaction, a POS device transaction, a grocery store transaction, and/or a merchant category code “5411” transaction.

Also regarding block 110, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, passcode (e.g., primary passcode), expiration date of debit card or credit card, name(s) of holder(s) of the account, etc.) at the transaction machine. For example, in some embodiments, where the transaction machine is a POS device, the holder presents account information at the transaction machine by swiping a debit card or credit card through the POS device. As another example, in some embodiments, the holder presents account information at the transaction machine by inputting account information into the transaction machine via a user interface associated with the transaction machine. As still another example, in some embodiments, the holder presents account information at the transaction machine by “tapping” an NFC-enabled mobile device at an NFC-enabled transaction machine (e.g., holding the NFC interface of the mobile device within approximately four inches of the NFC interface of the transaction machine, etc.) in order to communicate the account information from the mobile device to the transaction machine.

Additionally or alternatively, the apparatus can be configured to receive the transaction information directly or indirectly from the source of the transaction. For example, in some embodiments, the apparatus is located remotely from the transaction machine but is operatively connected to the transaction machine via a network (e.g., a payment network). As another example, the apparatus may include, be included in, and/or be embodied as a transaction machine. For example, in some embodiments, the apparatus having the process flow 100 includes the transaction machine referred to in block 110. As another example, in some embodiments, the apparatus having the process flow 100 is embodied as the mobile device referred to in block 130. As still another example, in some embodiments, the apparatus having the process flow 100 is embodied as a transaction machine separate from, and/or different than, the transaction machine and/or mobile device mentioned in the process flow 100.

Regarding block 120, the fraud rule may be defined by any party. For example, in some embodiments, the fraud rule is defined by the account holder and/or by his financial institution before the transaction referred to in block 110 is initiated. Also, the fraud rule may be defined in any way and/or relate to any aspect of a transaction. In some embodiments, the fraud rule relates to a merchant involved in the transaction, such that the apparatus having the process flow 100 determines that the fraud rule has been triggered if the transaction involves a merchant from a predetermined group of merchants. For example, in some embodiments, the fraud rule may be triggered if the holder's account is used to engage in a transaction with a jewelry store that is on a predetermined list of jewelry stores.

Additionally or alternatively, in some embodiments, the fraud rule relates to the transaction amount of the transaction, such that the apparatus determines that the fraud rule has been triggered if the transaction amount of the transaction is greater than a predetermined amount. For example, in some embodiments, the fraud rule may be triggered if the holder's account is used to engage in a transaction having a transaction amount greater than $500. In other embodiments, the fraud rule relates to the type of the transaction, such that the fraud rule is triggered if the transaction is associated with a merchant category code from a predetermined group of merchant category codes. For example, in some embodiments, the fraud rule may be triggered if the holder's account is used to engage in a transaction involving the merchant category code “5933” for pawn shops, where that merchant category code is one of several predetermined merchant category codes.

In some embodiments, the fraud rule relates to the location of the transaction, such that the apparatus having the process flow 100 determines that the fraud rule has been triggered if the holder's account is used to engage in a transaction outside of a predetermined geographic area. For example, in some embodiments, where the account holder resides in North Carolina, the fraud rule may be triggered if the holder's account is used to engage in a transaction in northern Virginia. Additionally or alternatively, in some embodiments, the fraud rule relates to one or more products involved in the transaction. For example, in some embodiments, the fraud rule may be triggered if the transaction involves gift cards, jewelry, guns, and/or some other predetermined product.

Still referring to block 120, in some embodiments, the fraud rule relates to the “transaction velocity” of the holder's account. In other words, the apparatus having the process flow 100 may determine that the fraud rule has been triggered if the transaction occurred within a predetermined period of time after a previous transaction involving the account occurred. For example, in some embodiments, the fraud rule may be triggered if the transaction referred to in block 110 is initiated within five minutes after the account was used to engage in a previous transaction. Of course, it will be understood that the fraud rule may relate to other aspects of the transaction referred to in block 110, including, but not limited to, the date of the transaction, the time the transaction occurred, the type of the transaction (e.g., the channel through which the transaction was conducted, etc.), and/or the like. Also, it will be understood that, in some embodiments, the phrase “determine that the transaction has triggered the fraud rule” means “determine that the transaction may involve misappropriation”.

Further regarding block 120, in some embodiments, the apparatus is embodied as an authorization apparatus (e.g., the authorization apparatus 330 referred to in FIG. 3, etc.) that is configured to consider, authorize, and/or decline authorization requests and/or financial transactions. The apparatus configured to perform the process flow 100 can be configured to make fraud rule determinations in real time and/or in substantially real time. In some embodiments, the apparatus is configured to make the fraud rule determination immediately or nearly immediately after the transaction has been initiated at the transaction machine (e.g., upon the swipe of a debit or credit card through a POS device, upon the holder selecting an amount to withdraw from an ATM, etc.). However, the apparatus can be configured to make the fraud rule determination at any time from when the holder approaches the transaction machine to when the holder leaves the transaction machine. Additionally or alternatively, the apparatus can be configured to make the fraud rule determination at any time from when the holder initiates and/or engages in the transaction at the transaction machine to when the transaction is completed.

Regarding block 130, the holder can be prompted to consent to the transaction in any way. In some embodiments, the holder is prompted via a mobile device, where the mobile device is associated with the holder. As used herein, the phrase “the mobile device is associated with the holder” means that the mobile device is carried, possessed, owned, and/or controlled by, and/or accessible to, the holder during the transaction (e.g., during the prompting referred to in block 130). In some embodiments, the mobile device can access an address that is associated with the account. The address can be any number and/or type of address(es) accessible to a mobile device. For example, in some embodiments, the address includes one or more phone numbers, text messaging service addresses, email addresses, social media network-specific addresses (e.g., username and/or other identifier for a social media account etc.), subscriber identity module (SIM) card information, serial numbers, and/or IP addresses that are associated with the mobile device. In some embodiments, because the address is accessible to the mobile device, any communication sent to the address may be displayed, outputted, rendered, and/or otherwise presented at the mobile device.

In some embodiments, the address is stored with account information in an account datastore, in an account profile associated with the account and/or holder, in an electronic banking account associated with the account, in a periodic statement associated with the account, and/or the like. For example, in some embodiments, the apparatus having the process flow 100 is configured to prompt the holder to consent to the transaction by a sending a fraud alert notification and/or text message to a mobile phone number identified in the holder's account profile. In some embodiments, the account holder provides the address to the financial institution that maintains the apparatus having the process flow 100 when the holder enrolls in a fraud messaging service and/or before the apparatus receives the transaction information referred to in block 110.

The mobile device can include any number and/or type of mobile device(s). Examples of mobile devices include mobile phones (e.g., feature phones, smart phones, etc.), mobile gaming devices, mobile computers (e.g., tablet computers, laptop computers, etc.), personal digital assistants (PDAs), and/or the like. In some embodiments, the mobile device is configured to send and/or receive communications (e.g., phone calls, text messages, actionable alerts, emails, social media-specific messages, etc.), present information via a user interface, play video games, and/or the like. In some embodiments, the mobile device is portable (e.g., not stationary) and/or can be carried and/or worn by and/or on a person.

In some embodiments, the mobile device includes one or more NFC interfaces that are configured to communicate with one or more NFC interfaces associated with the transaction machine. For example, in some embodiments, where the mobile device is embodied as a mobile phone, the mobile phone has an NFC interface that can communicate account information and/or transaction information (e.g., account names, routing numbers, account numbers, usernames, passwords, PINs, transaction amounts, etc.) to and/or from the NFC interface of another device (e.g., the transaction machine referred to in block 110). In some of these embodiments, the mobile phone is configured to operate as a mobile wallet, meaning that the mobile phone can be used to make payments and/or otherwise engage in transactions at a transaction machine.

Further regarding block 130, the prompting the holder may include sending and/or presenting one or more questions, instructions, requests, messages, graphics, sounds, phone calls, text messages (e.g., SMS messages, MMS messages, EMS messages, etc.), actionable alerts, instant messages, voice messages, voice recordings, interactive voice response (IVR) communications, pages, emails, communications specific to one or more social media networks and/or applications, and/or the like. For example, in some embodiments, the apparatus having the process flow 100 sends a text message to the holder's mobile phone, where the text message describes the transaction (e.g., date/time, merchant, transaction amount, etc.) and/or prompts the holder to consent to the transaction by return text message. As another example, in some embodiments, the apparatus sends a web page to the holder's mobile device that can be rendered at the mobile device to display an input feature (e.g., digital selectable button, link, etc.) that invites the holder to use the input feature to provide the holder's consent. As still another example, in some embodiments where the mobile device includes a speaker, the apparatus having the process flow 100 is configured to send a communication to the mobile device that causes the speaker to output one or more audible instructions that instruct the holder to, for example, depress a physical button and/or speak into a microphone located on and/or near the mobile device in order to provide the holder's consent.

Of course, it will also be understood that, instead of being prompted to consent via a mobile device, the holder may be prompted to consent to the transaction via the transaction machine involved in the transaction (e.g., the transaction machine referred to in block 110). For example, in some embodiments, where the transaction machine is embodied as a POS device, the apparatus having the process flow 100 is configured to send a message to the POS, where the message prompts the holder to consent to the transaction using the holder's mobile phone. As another example, in some embodiments, where the transaction machine is embodied as an ATM, the apparatus is configured to send a message to the ATM, where the message prompts the holder to consent to the transaction by inputting the holder's fraud passcode (described in more detail below) into the ATM. It will be understood that, in some embodiments, the apparatus prompts the holder to consent to the transaction by sending a message to the transaction machine via a payment network (instead of a telephone network).

Regarding blocks 130 and 140, the phrase “consent to the transaction,” as used herein, is meant to be understood in its broadest sense. For example, in some embodiments, the holder consents to the transaction by authorizing the transaction (e.g., where the holder knows that he or another authorized user is engaging in the transaction). As another example, in some embodiments, the holder consents to the transaction by agreeing to complete the transaction. As still another example, in some embodiments, the holder consents to the transaction by allowing the transaction to be completed. Additionally or alternatively, in some embodiments, the holder consents to the transaction by asserting (e.g., stating, maintaining, indicating, declaring, acknowledging, proving, etc.) that the holder or some other authorized user (e.g., the holder's spouse, the holder's child, etc.) is the one actually engaging in the transaction. In other embodiments, the holder consents to the transaction by asserting that no unauthorized user or dishonest individual is engaging in the transaction.

Regarding block 140, the holder may consent to the transaction using any device. In some embodiments, the holder consents via a mobile device associated with the holder. In some embodiments, this mobile device is the same mobile device through which the holder was prompted to consent to the transaction. It will be understood that the holder may consent to the transaction by using one or more input features (e.g., physical and/or digital buttons, microphones, etc.) provided by the mobile device and/or by a mobile banking application that executes on the mobile device. As another example, in some embodiments, the holder consents to the transaction by sending a text message (e.g., where the text message includes the term “Yes,” “Consent,” “Allow,” etc.) from the mobile device to the apparatus having the process flow 100.

In other embodiments, the holder consents to the transaction using the transaction machine (e.g., the transaction machine referred to in block 110). For example, in some embodiments, after being prompted to consent via the mobile device, the holder consents to the transaction by using one or more hardware and/or software input features provided by the transaction machine and/or by an application executing on the transaction machine. Accordingly, it will be understood that the holder may be prompted to consent to the transaction via a first channel (e.g., the mobile device, etc.) and then provide his consent to the transaction via a second channel (e.g., the transaction machine, etc.).

Referring again to blocks 130 and 140, in some embodiments, the holder consents to the transaction by providing a passcode to the apparatus having the process flow 100. For example, in some embodiments, (a) the apparatus prompts the holder, via the holder's mobile device, to provide a passcode associated with the holder's account in order to consent to the transaction; (b) the holder inputs the passcode into the mobile device after being prompted; and (c) the apparatus authorizes the transaction as a result of receiving the passcode via the mobile device. As another example, in some embodiments, (a) the apparatus prompts the holder, via the transaction machine, to provide a passcode associated with the holder's account in order to consent to the transaction; (b) the holder inputs the passcode into the holder's mobile device after being prompted; and (c) the apparatus authorizes the transaction as a result of receiving the passcode via the holder's mobile device.

The term “passcode,” as used herein, generally refers to a code, string, keyword, number, phrase, PIN, password, username, personal identifier, and/or the like that the holder uses to access banking services, to engage in transactions, and/or to consent to transactions. Indeed, in some embodiments, the passcode is required to access those banking services, to engage in those transactions, and/or to consent to those transactions. The passcode may be of any length and include any type of character. For example, in some embodiments, the passcode is a four or six digit PIN. Of course, it will be understood that, in other embodiments, the passcode is a different length and/or includes one or more letters and/or symbols in addition to, or instead of, numbers.

There are two kinds of passcodes referred to herein, a primary passcode and a fraud passcode. It will be understood that the primary passcode refers to a passcode typically used to engage in regular, day-to-day transactions and typically associated with the holder, the account, and/or the debit and/or credit card involved in those transactions. The fraud passcode also refers to a passcode that is associated with the holder, account, and/or debit and/or credit card involved in a transaction, but the fraud passcode is typically used to consent to transactions that the apparatus determines may involve misappropriation. Any given holder, account, and/or debit and/or credit card may be associated with a primary passcode and a fraud passcode, but in many embodiments, the primary passcode is different than the associated fraud passcode. For example, in some embodiments, the primary passcode associated with the account is the four digit PIN “###*,” whereas the fraud passcode associated with that account is the four digit PIN “###$.”

Also, in some embodiments, the primary passcode and/or the fraud passcode referred to in the process flow 100 may be selected by the holder and/or the holder's financial institution before the transaction referred to in the process flow 100 is initiated (e.g., when the holder enrolls in a fraud messaging service). However, in other embodiments, the fraud passcode is provided to the holder for the first time during the transaction referred to in the process flow 100 (e.g., via a message sent to the transaction machine or the holder's mobile device), such that the holder does not know the identity of the fraud passcode before the transaction is initiated. In some of these embodiments, the fraud passcode is dynamically generated, generated in real-time during the transaction, and/or automatically generated after the apparatus makes the fraud rule determination but before the apparatus authorizes the transaction.

Also, it will be understood that, in some embodiments, the primary and/or fraud passcodes are secret and/or confidential, such that, for example, the passcode(s) are known only to the holder and the holder's financial institution. Additionally or alternatively, in some embodiments, the holder's financial institution associates the passcode(s) with the holder, the account, and/or the debit and/or credit card associated with the account. Of course, because a financial institution may maintain millions of accounts, a particular passcode associated with one account may actually be the same passcode associated with another account. In such cases, the identity of the passcode cannot be used by itself to actually identify a holder of an account. However, in other embodiments of the present invention, the passcode(s) are uniquely associated with the holder, the account, and/or a debit and/or card associated with the account, such that, for example, the holder, the account, and/or the card may be identified simply by knowing the identity of the passcode(s) (and/or vice versa). Additionally or alternatively, in some embodiments, where the primary and/or fraud passcodes are secret and/or confidential, those passcode(s) may be used to authenticate the holder (e.g., verify that the holder is who he says he is) to the apparatus having the process flow 100, to the financial institution that maintains the account, and/or to a merchant and/or counterparty involved in the transaction.

It will be understood that the passcodes referred to herein may be different than a card verification value (CVV). As understood herein, a CVV is typically a three or four digit number that is printed on a debit and/or credit card, and that may be used, for example, during web or phone transactions, to verify that the card holder actually possesses the debit and/or credit card at the time of the transaction. In contrast, a passcode is not typically printed on a debit and/or credit card associated with the account. Further, because the CVV is typically printed on a card, anyone with access to that card may view the CVV. Thus, in embodiments where the primary and/or fraud passcodes are known only to the holder and his financial institution, the identities of those passcodes are typically secrets more closely guarded than the identity of the CVV.

Although not shown in FIG. 1, in some embodiments, the transaction information associated with the transaction referred to in block 110 includes the primary passcode, and the apparatus having the process flow 100 receives the fraud passcode after receiving the transaction information (and therefore after receiving the primary passcode). For example, in some embodiments, (a) the holder inputs the primary passcode into the transaction machine at and/or near the beginning of the transaction, such that the apparatus receives the primary passcode in the transaction information and/or before the apparatus makes the fraud rule determination, (b) as a result of making the fraud rule determination, the apparatus prompts the holder, via a mobile device associated with the holder, to provide the fraud passcode to complete the transaction, (d) the holder inputs the fraud passcode into the mobile device after being prompted, and (e) the apparatus authorizes the transaction as a result of receiving the fraud passcode.

Regarding block 150, the apparatus is configured to authorize the transaction based at least partially on the apparatus receiving the holder's consent, which in some embodiments, includes receives the holder's fraud passcode. It will be understood that the apparatus can be configured to authorize the transaction in any way. For example, in some embodiments, the apparatus is configured to authorize the transaction by sending, to the transaction machine, one or more instructions to complete (and/or for completing) the transaction. In some embodiments, the apparatus is configured to authorize the transaction by approving an authorization request associated with the transaction. In some embodiments, the authorization request approved by the apparatus having the process flow 100 was included in the transaction information referred to in block 110. In some embodiments, where the transaction machine referred to in block 110 is the apparatus having the process flow 100, the transaction machine authorizes and/or completes the transaction in response to receiving the holder's consent. In such embodiments, the transaction machine completes the transaction by performing one or more meaningful actions relevant to the transaction, such as, for example, dispensing cash, accepting a purchase transaction, accepting a check deposit, printing a receipt and/or statement, loading a prepaid storage card, transferring funds, and/or the like. In some embodiments, these one or more actions constitute the exchange central to the transaction, define the transaction, are desired by the holder to be performed, and/or were the reason the holder arrived at the transaction machine in the first place.

In accordance with some embodiments, the apparatus configured to perform the process flow 100 is configured to perform the portions of the process flow 100 represented by blocks 110-150 at some point after the holder (or some authorized user) approaches the transaction machine for the transaction and before the holder leaves the transaction machine. In some embodiments, this means that the apparatus is configured to perform the one or more portions of the process flow 100 (e.g., make the fraud rule determination, receive the holder's consent, authorize the transaction, etc.) during the transaction involving the transaction machine, and/or while the holder (or some authorized user) is still at the transaction machine.

The apparatus configured to perform the process flow 100 can be configured to perform any of the portions of the process flow 100 represented by blocks 110-150 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus configured to perform the process flow 100 is configured such that the apparatus receiving the transaction information (the triggering event) automatically and immediately or nearly immediately (e.g., within 3-30 seconds, etc.) triggers the apparatus to make the fraud rule determination (the triggered action). In some embodiments, the apparatus is additionally or alternatively configured to authorize and/or complete the transaction (triggered action) automatically and immediately or nearly immediately after receiving the holder's consent to the transaction (triggering event).

In accordance with some embodiments, the apparatus configured to perform the process flow 100 is configured to automatically perform one or more of the portions of the process flow 100 represented by blocks 110-150, whereas in other embodiments, one or more of the portions of the process flow 100 represented by blocks 110-150 require and/or involve human intervention (e.g., a user operating the apparatus configured to perform the process flow 100, etc.). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-5 minutes from start to finish, etc.). As an example, in some embodiments, the apparatus having the process flow 100 is configured to authorize and/or complete the transaction within moments, seconds, and/or minutes (e.g., within approximately 1-5 minutes, etc.) of: (a) receiving the transaction information associated with the transaction; (b) determining that the transaction has triggered the fraud rule; (c) prompting the holder to consent to the transaction; and/or (d) receiving the holder's consent.

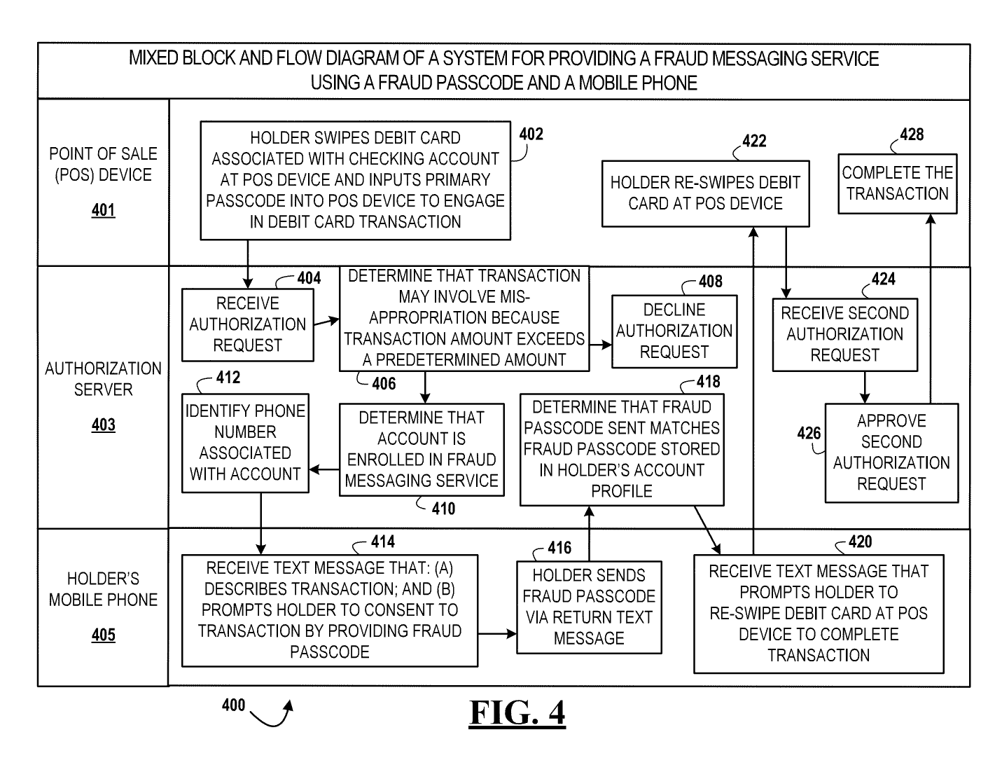

It will be understood that the apparatus having the process flow 100 can be configured to perform one or more portions of any embodiment described and/or contemplated herein, such as, for example, one or more portions of the process flow 200 described herein and/or one or more portions of the process flows described in connection with FIGS. 3, 3A, and 4. Also, the number, order, and/or content of the portions of the process flow 100 are exemplary and may vary. For example, in some alternative embodiments, the apparatus having the process flow 100 is configured to store a fraud passcode associated with the holder's account in a memory device (e.g., in an account profile associated with the account) before the transaction referred to in the process flow 100 is initiated. In such embodiments, the apparatus is also configured to receive the holder's consent to the transaction by receiving the holder's passcode. In such embodiments, after receiving the fraud passcode, the apparatus is further configured to determine that the fraud passcode received from the holder matches the fraud passcode stored in the memory device. In some of these embodiments, the apparatus is configured to authorize the transaction based at least partially on determining that the two fraud passcodes match.

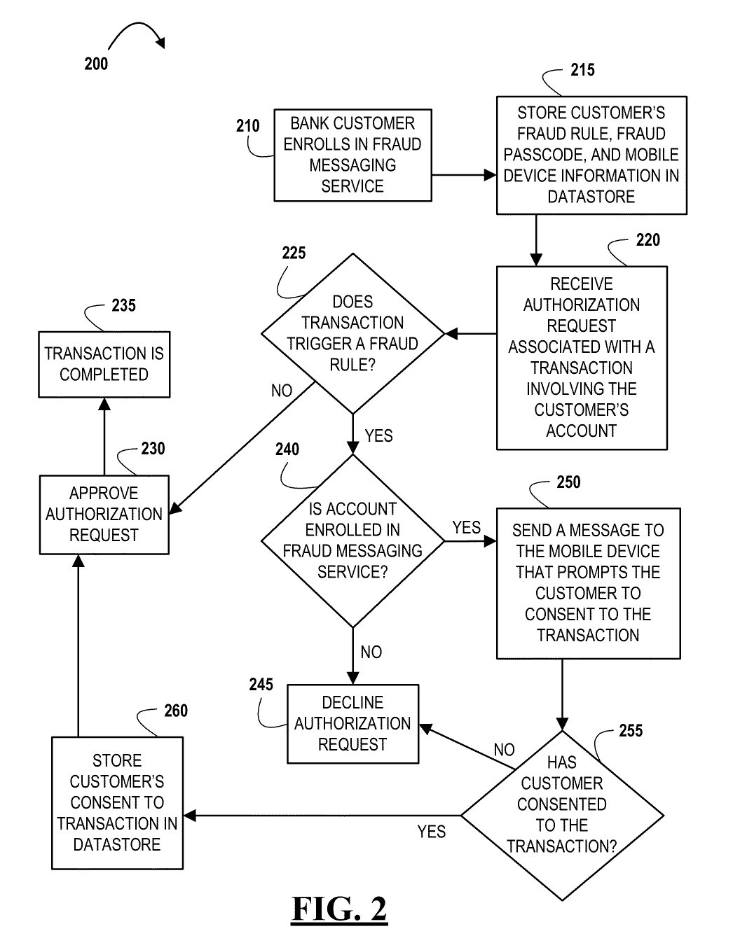

Referring now to FIG. 2, a more-detailed process flow 200 is illustrated for providing a fraud messaging service using a mobile device, in accordance with an embodiment of the present invention. It will be understood that the process flow 200 illustrated in FIG. 2 represents an example embodiment of the process flow 100 described in connection with FIG. 1. In accordance with some embodiments, one or more portions of the process flow 200 are performed by an apparatus having hardware and/or software configured to perform one or more portions of the process flow 200. For example, in some embodiments, one or more portions of the process flow 200 are performed, individually or collectively, by the transaction machine 320, the authorization apparatus 330, and/or the mobile device 340 described in connection with FIG. 3, and/or by any one or more portions (e.g., applications, etc.) thereof. Also, the apparatus having the process flow 200 may include, be included in, be embodied as, and/or be operatively connected to the transaction machine referred to in the process flow 200. In accordance with some embodiments, the apparatus having the process flow 200 is maintained by a bank for the benefit of its customers. Also in accordance with some embodiments, the customer referred to in the process flow 200 is the user of the transaction machine, a customer of the bank, and a holder of an account.

As represented by block 210, the bank customer enrolls himself and/or his account in a fraud messaging service provided by the bank, such as, for example, by online banking, mobile banking application, mail, banking center, call center, and/or the like. During enrollment, the apparatus having the process flow 200 may define (and/or the customer may define) one or more fraud rules associated with the holder's account. For example, in some embodiments, the customer defines a fraud rule that is triggered if the customer's account is involved in a transaction having a transaction amount greater than $200. As another example, in some embodiments, the financial institution defines a fraud rule that is triggered if the customer's account is involved in a transaction with a merchant associated with the merchant category code 5944 for jewelry stores.

Also during enrollment, the apparatus having the process flow 200 may select (and/or the customer may select) a fraud passcode for the customer and/or the customer's account. In some embodiments, this fraud passcode can used by the customer to consent to transactions that the apparatus may view as potentially involve misappropriation. For example, in some embodiments, the customer selects a fraud PIN that is easy to remember and/or similar to the primary PIN already associated with the customer's account. For example, the customer may select “###$” as the fraud PIN because his primary PIN is “###*”. In addition to defining fraud rules and selecting a fraud passcode, the apparatus having the process flow 200 is also configured to register the customer's mobile device during enrollment. For example, in some embodiments, where the mobile device is a mobile phone, the customer provides the phone number associated with the mobile phone to the apparatus. After enrollment and/or as a result of enrollment, the apparatus is configured to store the customer's fraud rule, fraud passcode, and mobile device information in a datastore (e.g., the account datastore 338, etc.), as represented by block 215. In some embodiments, this information is stored in an account profile associated with the account and/or the customer, where the account profile and many other account profiles are stored in the datastore.

Sometime after the customer enrolls in the fraud messaging service, the apparatus having the process flow 200 receives an authorization request associated with a transaction involving the customer's account, as represented by block 220. In some embodiments, the authorization request identifies and/or describes the transaction, the account, the debit and/or credit card associated with the account, a primary passcode (e.g., primary PIN) associated with the account, and/or the like. After receiving the authorization request, the apparatus must determine whether the transaction triggers a fraud rule associated with the customer's account, as represented by block 225. In other words, the apparatus is configured to determine whether the transaction may involve misappropriation.

If the apparatus determines that the transaction does not trigger a fraud rule, then the apparatus having the process flow 200 approves the authorization request, as represented by block 230, and the transaction is completed at the transaction machine, as represented by block 235. However, if the apparatus determines that the transaction does trigger a fraud rule, then the apparatus must determine whether the account involved in the transaction is enrolled in the bank's fraud messaging service, as represented by block 240. Of course, in this example embodiment, the customer's account is enrolled in the fraud messaging service. However, in other embodiments, if the account involved in the transaction was not enrolled, then the apparatus would decline the authorization request and/or otherwise decline, cancel, abort, and/or reject the transaction, as represented by block 245.

Once the apparatus determines that the customer's account is enrolled in the fraud messaging service, the apparatus is configured to send a message to the mobile device associated with the account, where the message prompts the customer the account to consent to the transaction, as represented by block 250. In so doing, the apparatus is configured to determine whether the customer or some other authorized user is the person engaging in the transaction, or whether an unauthorized user or dishonest individual is the person engaging in the transaction. In some embodiments, the apparatus is configured to send this message and/or otherwise prompt the customer within about fourteen (14) seconds of: (a) determining that the transaction has triggered the fraud rule; (b) receiving the authorization request; and/or (c) the transaction machine sending the authorization request.

The message referred to in block 250 may be any number and/or type of communication(s). For example, the message sent may be one or more text messages, phone calls, emails, actionable alerts, audible outputs, mobile banking application-specific messages, social media-specific messages and/or the like. The message may be generated, rendered, displayed, and/or otherwise output visually (e.g., via a display) and/or audibly (e.g., via a speaker). In addition, the message may include any amount and/or type of information. For example, in some embodiments, the message includes explicit instructions for the customer (e.g., “Your account has been used to engage in a $350 transaction at Store A. We think this transaction may involve misappropriation. To allow this transaction, please text ‘YES’ to XXX-XXX-XXXX”). Additionally or alternatively, the message may prompt the customer to input the fraud passcode associated with the customer's account (e.g., “Did you engage in a $100 transaction at Store B? If so, please text your fraud passcode to XXX-XXX-XXXX to complete the transaction.”).

In some alternative embodiments, instead of the customer selecting or being assigned the fraud passcode during the enrollment process, the customer is first provided the fraud passcode via the message referred to in block 250 and/or at some point after the transaction is initiated. For example, in some alternative embodiments, the apparatus having the process flow 200 is configured to send a message to the customer after the apparatus determines that the transaction has triggered the fraud rule, where the message: (a) describes the potentially transaction involving misappropriation (e.g., transaction amount, merchant, products involved, date, time, etc.), etc.; (b) provides the customer with a fraud passcode for use in consenting to the transaction; and/or (c) prompts the customer to input the fraud passcode into the transaction machine involved in the potentially transaction involving misappropriation if the customer wishes to complete the transaction. In some of these embodiments, the fraud passcode is a dynamically-generated and/or one-time fraud passcode, and/or is valid for only one transaction and/or for only the transaction referred to in the process flow 200.

Returning to FIG. 2, after prompting the customer via the mobile device, the apparatus is configured to determine whether the customer has consented to the transaction within a predetermined period of time, as represented by block 255. If the customer does not consent within the predetermined period of time (e.g., thirty seconds, two minutes, five minutes, etc.), then the apparatus is configured to decline the transaction, as represented by block 245. It will be understood that the apparatus can make this determination in at least one of two ways: (a) if the customer does not respond to the prompting within the predetermined period of time; or (b) if the customer responds to the prompting within the predetermined period of time, but indicates that he does not wish to allow the transaction. On the other hand, if the customer does consent to the transaction within the predetermined period of time, then the apparatus is configured to store the customer's consent to the transaction in a datastore, as represented by block 260, and then approve the authorization request, as represented by block 230.

It will be understood that the customer may consent to the transaction in any way. For example, in some embodiments, the customer consents to the transaction by sending a message from the customer's mobile phone to the apparatus, where the message indicates that the customer: (a) agrees to allow the transaction; (b) has authorized the transaction; and/or (c) asserts that the customer is the party involved in the transaction. Additionally or alternatively, in some embodiments, the customer consents to the transaction by providing the customer's fraud passcode to the apparatus having the process flow 200. For example, in some embodiments, the customer inputs the fraud passcode into the keypad of the transaction machine involved in the transaction. As another example, in some embodiments, the customer sends the fraud passcode from the mobile device to the apparatus via text message.

Although not shown in FIG. 2, in some embodiments, the apparatus having the process flow 200 is configured to authorize the transaction based at least partially on the holder consenting to the transaction via the holder's mobile device (or via the transaction machine). Also, in some embodiments, the apparatus having the process flow 200 is configured to determine that the customer has consented to the transaction based at least partially on determining that the fraud passcode sent by the customer matches the fraud passcode associated with the customer's account and stored in the account datastore referred to in block 215.

Also, it will be understood that, in the example embodiment shown in FIG. 2, the apparatus having the process flow 200 is configured to prompt the customer during the transaction (e.g., after the transaction has been initiated but before the transaction has been authorized and/or completed). As such, the customer is able to help the apparatus determine whether the transaction involving the customer's account involves misappropriation. This cooperation reduces or eliminates the possibility that the customer's unusual but legitimate transactions will be declined. This also reduces or eliminates the possibility that the customer's account will be used to make transactions involving misappropriation because the customer is able to decline and/or stop any potentially transaction involving misappropriation that the customer does not recognize.

Of course, it will also be understood that the embodiment illustrated in FIG. 2 is merely exemplary and that other embodiments may vary without departing from the scope and spirit of the present invention. For example, in some alternative embodiments, the apparatus having the process flow 200 is configured to prompt the customer, via the transaction machine, to consent to the transaction (e.g., where the customer then consents via the customer's mobile device).

In addition, it will also be understood that the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 210-260 upon or after one or more triggering events (which, in some embodiments, is the performance of one or more of the other portions of the process flow 200). In addition, in some embodiments, the apparatus having the process flow 200 (and/or a customer thereof) is configured to perform one or more portions (or combinations of portions) of the process flow 200, from start to finish, within moments, seconds, and/or minutes (e.g., within approximately 1-15 minutes, etc.).

Referring now to FIG. 3, a system 300 for providing a fraud messaging service is provided, in accordance with an embodiment of the present invention. As illustrated, the system 300 includes a network 310, a transaction machine 320, an authorization apparatus 330, and a mobile device 340. FIG. 3 also shows an account holder 302 and a profile 308 of an account (e.g., checking account, savings account, credit card account, LOC account, HELOC account, etc.), where the profile 308 is stored in the account datastore 338 of the authorization apparatus 330. The account is held by the holder 302, maintained by a financial institution at which the holder 302 is a customer, and is associated with the account profile 308. As shown, the account profile 308 includes account information 308A associated with the account (and/or holder 302), a primary passcode 308B associated with the account (and/or holder 302), a fraud passcode 308C associated with the account (and/or holder 302), and one or more fraud rules 308D associated with the account (and/or the holder 302). In some embodiments, the holder 302 may access the account profile 308 via online banking, mobile banking, and/or text banking.

FIG. 3 also shows an unauthorized user 303, which may be someone posing as the account holder 302 and/or someone trying to use the holder's account without authorization from the holder 302. In this example embodiment, the unauthorized user 303 has access to the transaction machine 320, and may have access to information associated with the holder's account. The holder 302 also potentially has access to the transaction machine 320, but unlike the unauthorized user 303, has access to the mobile device 340.

In accordance with some embodiments, the transaction machine 320 and the authorization apparatus 330 are each maintained by the same financial institution. For example, in some embodiments, the holder 302 is a customer of the financial institution, the authorization apparatus 330 is embodied as an ATM transaction server maintained by the financial institution, and the transaction machine 320 is embodied as an ATM maintained by the financial institution. However, in other embodiments, the transaction machine 320 and the authorization apparatus 330 are maintained by separate entities. For example, in some embodiments, the transaction machine 320 is embodied as a POS device maintained by a merchant, and the authorization apparatus 330 is embodied as an authorization server maintained by a financial institution. In accordance with some embodiments, the mobile device 340 is associated with the holder 302 and/or is carried, owned, possessed, and/or owned by the holder 302.

As shown in FIG. 3, the transaction machine 320, the authorization apparatus 330, and the mobile device 340 are each operatively and selectively connected to the network 310, which may include one or more separate networks. The network 310 may include one or more payment networks (e.g., interbank networks, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 310 includes a telephone network (e.g., for communicating with the mobile device 340, etc.) and a payment network (e.g., for communicating with the transaction machine 320, etc.). It will also be understood that the network 310 may be secure and/or unsecure and may also include wireless and/or wireline technology.

The transaction machine 320 may include any computerized apparatus that can be configured to perform any one or more of the functions of any apparatus described and/or contemplated herein. For example, in some embodiments, the transaction machine 320 includes and/or is embodied as an ATM, a POS device, a self-checkout machine, a vending machine, a ticketing kiosk, a personal computer, a gaming device, a mobile phone, and/or the like. As another example, in some embodiments, the transaction machine 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); accessing and/or navigating the Internet; and/or the like.

In some embodiments, the transaction machine 320 (and/or one or more other portions of the system 300) requires its users to authenticate themselves to the transaction machine 320 (and/or one or more other portions of the system 300) before the transaction machine 320 will initiate, perform, complete, and/or facilitate a transaction. For example, in some embodiments, the transaction machine 320 (and/or the transaction application 327) is configured to authenticate a transaction machine user based at least partially on an ATM/debit/credit card, loyalty/rewards/club card, smart card, token (e.g., USB token, etc.), username/password, PIN, biometric information, and/or one or more other credentials that the user presents to the transaction machine 320. Additionally or alternatively, in some embodiments, the transaction machine 320 is configured to authenticate a user by using one-, two-, or multi-factor authentication. For example, in some embodiments, the transaction machine 320 requires two-factor authentication, such that the holder 302 must provide a valid debit card and enter the correct PIN (e.g., the primary passcode 308B) in order to authenticate the holder 302 to the transaction machine 320.

As illustrated in FIG. 3, in this example embodiment, the transaction machine 320 includes a communication interface 322, a processor 324, a memory 326 having a transaction application 327 stored therein, and a user interface 329. The processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the transaction machine 320, to send, receive, and/or otherwise communicate information to and/or from the communication interface of one or more other portions of the system 300. For example, the communication interface 322 of the transaction machine 320 may include a modem, network interface controller (NIC), NFC interface, network adapter, network interface card, and/or some other electronic communication device that operatively connects the transaction machine 320 to another portion of the system 300, such as, for example, the authorization apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the transaction application 327 of the memory 326 of the transaction machine 320.

Each memory device described herein, including the memory 326 for storing the transaction application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the transaction application 327. It will be understood that the transaction application 327 can be operable (e.g., usable, executable, etc.) to initiate, perform, complete, and/or facilitate one or more portions of any embodiment described and/or contemplated herein, such as, for example, one or more portions of the process flows 100 and/or 200 described herein and/or one or more portions of the process flows described in connection with FIG. 4.

For example, in some embodiments, the transaction application 327 is operable to receive transaction information associated with a transaction. As another example, in some embodiments, the transaction application 327 is operable to determine, based at least partially on the transaction information, that the transaction may involve misappropriation and/or has triggered a fraud rule (e.g., one or more of the fraud rules 308D associated with the account). The transaction application 327 can also be operable to prompt the holder 302 to consent to the transaction based at least partially on making the fraud rule determination. In some embodiments, the transaction application 327 is operable to prompt the holder 302 via the mobile device 340. In other embodiments, the transaction application 327 is operable to prompt the holder 302 via the transaction machine 320. Still further, in some embodiments, the transaction application 327 is operable to prompt the holder 302 to provide a passcode (e.g., the primary passcode 308B, the fraud passcode 308C) in order to consent to the transaction. In some embodiments, the holder 302 inputs the passcode into the transaction machine 320, but in other embodiments, the holder 302 inputs the passcode into the mobile device 340.

The transaction application 327 can also be operable to receive the holder's consent to the transaction (e.g., where the holder 302 is the one actually engaging in the transaction). In some embodiments, the transaction application 327 receives the holder's consent by receiving the fraud passcode 308C. In other embodiments, the transaction application 327 receives a message from the holder indicating that the holder does not consent to the transaction (e.g., where the unauthorized user 303—and not the holder 302—is engaging in the transaction). Depending on whether the holder 302 consents to the transaction, the transaction application 327 can be operable to authorize the transaction (e.g., if the holder consents) or decline the transaction (e.g., if the holder does not consent, if the holder does not respond to the prompting within a predetermined period of time, etc.).

In some embodiments, where the transaction machine 320 includes and/or is embodied as an ATM, the transaction application 327 is configured to execute on the ATM in order to initiate, perform, complete, and/or facilitate, for example, one or more cash withdrawals, deposits, and/or the like. In other embodiments, where the transaction machine 320 includes and/or is embodied as a POS device, the transaction application 327 is configured to execute on the POS device in order to initiate, perform, complete, and/or facilitate, for example, one or more debit card and/or credit card transactions. In still other embodiments, where the transaction machine 320 includes and/or is embodied as a personal computer, the transaction application 327 is configured to execute on the personal computer, and, in some embodiments, the transaction application 327 is embodied as a web browser (i.e., for navigating the Internet, etc.) that is operable to initiate, perform, complete, and/or otherwise facilitate one or more financial and/or non-financial transactions.

In some embodiments, the transaction application 327 is operable to enable the holder 302 and/or transaction machine 320 to communicate with one or more other portions of the system 300, and/or vice versa. In some embodiments, the transaction application 327 is additionally or alternatively operable to initiate, perform, complete, and/or otherwise facilitate one or more financial and/or non-financial transactions (e.g., at the transaction machine 320). In some embodiments, the transaction application 327 includes one or more computer-executable program code portions for causing and/or instructing the processor 324 to perform one or more of the functions of the transaction application 327 and/or transaction machine 320 described and/or contemplated herein. In some embodiments, the transaction application 327 includes and/or uses one or more network and/or system communication protocols.

As shown in FIG. 3, the transaction machine 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the transaction machine user (e.g., the holder 302, the unauthorized user 303, etc.), such as, for example, one or more displays, speakers, receipt printers, dispensers (e.g., cash dispensers, ticket dispensers, merchandise dispensers, etc.), and/or the like. In some embodiments, the user interface 329 additionally or alternatively includes one or more user input devices, such as, for example, one or more buttons, keys, dials, levers, directional pads, joysticks, keyboards, keypads, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the transaction machine user (e.g., the holder 302, etc.). In some embodiments, the user interface 329 and/or the transaction machine 320 includes one or more vaults, security sensors, locks, and/or anything else typically included in and/or near the transaction machine.

FIG. 3 also illustrates an authorization apparatus 330, in accordance with an embodiment of the present invention. The authorization apparatus 330 may be embodied as any apparatus described and/or contemplated herein. In some embodiments, the authorization apparatus 330 includes and/or is embodied as one or more servers, engines, mainframes, personal computers, ATMs, network devices, front end systems, back end systems, and/or the like. In some embodiments, such as the one illustrated in FIG. 3, the authorization apparatus 330 includes a communication interface 332, a processor 334, and a memory 336, which includes an authorization application 337 and an account datastore 338 stored therein. As shown, the communication interface 332 is operatively and selectively connected to the processor 334, which is operatively and selectively connected to the memory 336.

The authorization application 337 can be operable (e.g., usable, executable, etc.) to initiate, perform, complete, and/or facilitate any one or more portions of the process flows 100 and/or 200 described herein and/or one or more portions of the process flows described in connection with FIG. 4. For example, in some embodiments, the authorization application 337 is operable to receive transaction information associated with a transaction. As another example, in some embodiments, the authorization application 337 is operable to determine, based at least partially on the transaction information, that the transaction may involve misappropriation and/or has triggered a fraud rule (e.g., one or more of the fraud rules 308D associated with the account).

The authorization application 337 can also be operable to prompt the holder 302 to consent to the transaction based at least partially on making the fraud rule determination. In some embodiments, the authorization application 337 is operable to prompt the holder 302 via the mobile device 340. In other embodiments, the authorization application 337 is operable to prompt the holder 302 via the transaction machine 320. Still further, in some embodiments, authorization application 337 is operable to prompt the holder 302 to provide a passcode (e.g., the primary passcode 308B, the fraud passcode 308C) to consent to the transaction. In some embodiments, the holder 302 inputs the passcode into the transaction machine 320, but in other embodiments, the holder 302 inputs the passcode into the mobile device 340.

The authorization application 337 can also be operable to receive the holder's consent to the transaction (e.g., where the holder 302 is the one actually engaging in the transaction). In some embodiments, the authorization application 337 receives the holder's consent by receiving the fraud passcode 308C. The authorization application 337 can also be operable to receive a message from the holder indicating that the holder does not consent to the transaction (e.g., where the unauthorized user 303—and not the holder 302—is engaging in the transaction). Depending on whether the holder 302 consents to the transaction, the authorization application 337 can be operable to authorize the transaction (e.g., if the holder consents) or decline the transaction (e.g., if the holder does not consent, if the holder does not respond to the prompting in a predetermined period of time, etc.).

In some embodiments, the authorization application 337 is operable to enable the authorization apparatus 330 to communicate with one or more other portions of the system 300, such as, for example, the account datastore 338, the mobile device 340, and/or the transaction machine 320, and/or vice versa. In addition, in some embodiments, the authorization application 337 is operable to initiate, perform, complete, and/or otherwise facilitate one or more financial and/or non-financial transactions. In some embodiments, the authorization application 337 includes one or more computer-executable program code portions for causing and/or instructing the processor 334 to perform one or more of the functions of the authorization application 337 and/or the authorization apparatus 330 that are described and/or contemplated herein. In some embodiments, the authorization application 337 includes and/or uses one or more network and/or system communication protocols.

In addition to the authorization application 337, the memory 336 also includes the account datastore 338. As shown, the account datastore 338 stores the account profile 308, which includes account information 308A, the primary passcode 308B, the fraud passcode 308C, and the one or more fraud rules 308D. The account information 308A may include any information associated with the account held by the holder 302, including, for example, information associated with one or more authorized users (e.g., the holder 302, the holder's spouse, etc.), transaction histories, account preferences, billing information, the terms and conditions associated with the account, and/or the like. The primary passcode 308B may include any information associated with a primary passcode, such as, for example, the primary passcode itself, when the primary passcode was selected by the holder 302 or assigned by the financial institution maintaining the account and/or providing the fraud messaging service, when the primary passcode was last used, etc. The fraud passcode 308C may include any information associated with a fraud passcode, including, for example, the fraud passcode itself, when the fraud passcode was selected by the holder 302 or assigned by the financial institution maintaining the amount and/or providing the fraud messaging service, when the fraud passcode was last used, etc. The fraud rules 308D may include any fraud rule described and/or contemplated herein, including those relating to transaction amounts, merchants, merchant category codes, transaction locations, and the like.

It will be understood that the account datastore 338 can be configured to store any type and/or amount of information. In addition to the account profile 308, the account datastore 338 may include information associated with one or more account holders (e.g., the holder 302, account holders other than the holder 302), account profiles (i.e., other than the account profile 308), financial accounts (i.e., other than the account held by the holder 302), transaction machines, transaction machine users, transactions, electronic banking accounts, primary passcodes, fraud passcodes, fraud rules, mobile devices, fraud messaging services, authorization requests, and/or the like. In some embodiments, the account datastore 338 may also store any information related to providing a fraud messaging service using a fraud passcode. In some embodiments, the account datastore 338 additionally or alternatively stores information associated with electronic banking (e.g., online banking, mobile banking, text banking, etc.) and/or electronic banking accounts.

In accordance with some embodiments, the account datastore 338 may include any one or more storage devices, including, but not limited to, datastores, databases, and/or any of the other storage devices typically associated with a computer system. It will also be understood that the account datastore 338 may store information in any known way, such as, for example, by using one or more computer codes and/or languages, alphanumeric character strings, data sets, figures, tables, charts, links, documents, and/or the like. Further, in some embodiments, the account datastore 338 includes information associated with one or more applications, such as, for example, the authorization application 337 and/or the transaction application 327. In some embodiments, the account datastore 338 provides a real-time or near real-time representation of the information stored therein, so that, for example, when the processor 334 accesses the account datastore 338, the information stored therein is current or nearly current. Although not shown, in some embodiments, the transaction machine 320 includes a transaction datastore that is configured to store any information associated with the transaction machine 320, the transaction application 327, and/or the like. It will be understood that the transaction datastore can store information in any known way, can include information associated with anything shown in FIG. 3, and/or can be configured similar to the account datastore 338.

Referring now to FIG. 3A, a block diagram is provided that illustrates the mobile device 340 of FIG. 3 in more detail, in accordance with an embodiment of the invention. In some embodiments, the mobile device 340 is a mobile phone (e.g., feature phones, smart phones, etc.), but in other embodiments, the mobile device 340 can include and/or be embodied as any other mobile device, including, but not limited to, mobile gaming devices, mobile computers (e.g., tablet computers, laptop computers, etc.), personal digital assistants (PDAs), and/or the like. In some embodiments, the mobile device is configured to send and/or receive communications (e.g., phone calls, text messages, actionable alerts, emails, social media-specific messages, etc.), present information via a user interface, play video games, and/or the like. In some embodiments, the mobile device is portable (e.g., not stationary) and/or can be carried and/or worn by and/or on a person. As shown in FIG. 3A, the mobile device 340 generally includes a processor 344 operatively connected to such devices as a memory 346, user interface 349 (i.e., user output devices 349A and user input devices 349B), a communication interface 342, a power source 345, a clock or other timer 343, a camera 341, and a positioning system device 390.

The processor 344 may include the functionality to encode and interleave messages and data prior to modulation and transmission. The processor 344 can additionally include an internal data modem. Further, the processor 344 may include functionality to operate one or more software programs, which may be stored in the memory 346. For example, the processor 344 may be capable of operating a connectivity program, such as a web browser application 348. The web browser application 348 may then allow the mobile device 340 to transmit and receive web content, such as, for example, location-based content and/or other web page content, according to a Wireless Application Protocol (WAP), Hypertext Transfer Protocol (HTTP), and/or the like.

The processor 344 is configured to use the communication interface 342 to communicate with one or more other devices on the network 310. In this regard, the communication interface 342 includes an antenna 376 operatively coupled to a transmitter 374 and a receiver 372 (together a “transceiver”). The processor 344 is configured to provide signals to and receive signals from the transmitter 374 and receiver 372, respectively. The signals may include signaling information in accordance with the air interface standard of the applicable cellular system of the wireless telephone network 310. In this regard, the mobile device 340 may be configured to operate with one or more air interface standards, communication protocols, modulation types, and access types. By way of illustration, the mobile device 340 may be configured to operate in accordance with any of a number of first, second, third, and/or fourth-generation communication protocols and/or the like. For example, the mobile device 340 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 340 may also be configured to operate in accordance with non-cellular communication mechanisms, such as via a wireless local area network (WLAN) or other communication/data networks.

The communication interface 342 may also include a near field communication (NFC) interface 370. As used herein, the phrase “NFC interface” generally refers to hardware and/or software that is configured to contactlessly and/or wirelessly send and/or receive information over relatively short ranges (e.g., within four inches, within three feet, within fifteen feet, etc.). The NFC interface 370 may include a smart card, key card, proximity card, Bluetooth® device, radio frequency identification (RFID) tag and/or reader, transmitter, receiver, and/or the like. In some embodiments, the NFC interface 370 communicates information via radio, infrared (IR), and/or optical transmissions. In some embodiments, the NFC interface 370 is configured to operate as an NFC transmitter and/or as an NFC receiver (e.g., an NFC reader, etc.). In some embodiments, the NFC interface 370 enables the mobile device 340 to operate as a mobile wallet. Also, it will be understood that the NFC interface 370 may be embedded, built, carried, and/or otherwise supported in and/or on the mobile device 340. In some embodiments, the NFC interface 370 is not supported in and/or on the mobile device 340, but the NFC interface 370 is otherwise operatively connected to the mobile device 340 (e.g., where the NFC interface 370 is a peripheral device plugged into the mobile device 340, etc.). Other apparatuses having NFC interfaces mentioned herein may be configured similarly.

In some embodiments, the NFC interface 370 of the mobile device 340 is configured to contactlessly and/or wirelessly communicate information to and/or from a corresponding NFC interface of another apparatus (e.g., the transaction machine 320, etc.). For example, in some embodiments, the mobile device 340 is a mobile phone, the NFC interface 370 is a smart card having account information stored therein, and the transaction machine 320 is a POS device having an NFC reader operatively connected thereto. In such embodiments, when the mobile phone and/or smart card is brought within a relatively short range of the NFC reader, the smart card is configured to wirelessly and/or contactlessly send the account information to the NFC reader in order to, for example, initiate, perform, complete, and/or otherwise facilitate a transaction.

In addition to the NFC interface 370, the mobile device 340 can have a user interface 349 that is, like other user interfaces described herein, made up of one or more user output devices 349A and/or user input devices 349B. The user output devices 349A include a display 380 (e.g., a liquid crystal display and/or the like) and a speaker 382 and/or other audio device, which are operatively coupled to the processor 344. The user input devices 349B, which allow the mobile device 340 to receive data from a user such as the holder 302, may include any of a number of devices allowing the mobile device 340 to receive data from a user, such as a keypad, keyboard, touch-screen, touchpad, microphone, mouse, joystick, other pointer device, button, soft key, and/or other input device(s). The user interface 349 may also include a camera 341, such as a digital camera.

In some embodiments, the mobile device 340 also includes a positioning system device 390 that can be used to determine the location of the mobile device 340. For example, the positioning system device 390 may include a GPS transceiver. In some embodiments, the positioning system device 390 includes a compass. In some embodiments, the positioning system device 390 is at least partially made up of the antenna 376, transmitter 374, and receiver 372 described above. For example, in one embodiment, triangulation of cellular signals may be used to identify the approximate location of the mobile device 340. In other embodiments, the positioning system device 390 includes a proximity sensor and/or transmitter, such as an RFID tag, that can sense or be sensed by devices known to be located proximate a merchant and/or other location to determine that the mobile device 340 is located proximate these known devices.

The mobile device 340 further includes a power source 345, such as a battery, for powering various circuits and other devices that are used to operate the mobile device 340. Embodiments of the mobile device 340 may also include a clock or other timer 343 configured to determine and, in some cases, communicate actual or relative time to the processor 344 or one or more other devices.

The mobile device 340 also includes a memory 346 operatively connected to the processor 344. As used herein, memory includes any computer readable medium (as defined herein) configured to store data, code, and/or other information. The memory 346 may include volatile memory, such as volatile Random Access Memory (RAM) including a cache area for the temporary storage of data. The memory 346 may also include non-volatile memory, which can be embedded and/or may be removable. The non-volatile memory can additionally or alternatively include an electrically erasable programmable read-only memory (EEPROM), flash memory or the like.

The memory 346 can store any of a number of applications which may include computer-executable instructions/code executed by the processor 344 to implement the functions of the mobile device 340 described herein. For example, the memory 346 may include a mobile banking application 347. This application can be operable (e.g., usable, executable, etc.) to initiate, perform, complete, and/or facilitate any one or more portions of the process flows 100 and/or 200 described herein and/or one or more portions of the process flows described in connection with FIG. 4. For example, in some embodiments, the mobile banking application 347 is operable to prompt, via the user interface 349, the holder 302 to consent to a transaction. In some of these embodiments, the mobile banking application 347 is operable to prompt the holder 302 to consent by providing a fraud passcode 308C. As still another example, in some embodiments, the mobile banking application 347 is operable to receive, via the user interface 349, the holder's 302 consent to the transaction (which, in some embodiments, is the fraud passcode 308C). As still another example, in some embodiments, the mobile banking application 347 is operable to generate and/or provide the holder 302 with a one-time, dynamic, random, and/or transaction-specific fraud passcode 308C, which may be input into the mobile device 340 and/or transaction machine 320 to, for example, consent to the transaction.

In some embodiments, the mobile banking application 347 provides a graphical user interface (GUI) on the display 380 that allows the holder 302 to communicate with the mobile device 340, the transaction machine 320, the authorization apparatus 330, and/or one or more other portions of the system 300. In some embodiments, the holder 302 can use the mobile banking application 347 to access the holder's account via an electronic banking service (e.g., mobile banking, text banking, etc.). The memory 346 can also store any type and/or amount information used by the mobile device 340. The memory 346 can also store any type and/or amount of information used by the applications and/or the devices that make up the mobile device 340, and/or that are in communication with the mobile device 340. For example, in some embodiments, the memory 346 stores account information (e.g., routing and/or account numbers, account names, username/passwords, primary passcodes, fraud passcodes, biometric information, etc.) associated with the holder 302 and/or account.

The embodiments illustrated in FIGS. 3 and 3A are exemplary and other embodiments may vary. For example, in some embodiments, some or all of the portions of the system 300 are combined into a single portion. Specifically, in some embodiments, the transaction machine 320 and the authorization apparatus 330 are combined into a single transaction and authorization apparatus that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, and/or any one or more embodiments of the process flow described and/or contemplated herein in connection with FIG. 4.

As a specific example, in accordance with an embodiment of the present invention, the authorization apparatus 330 is configured to: (a) receive transaction information associated with a transaction, where the transaction involves the transaction machine 320 and the holder's account, as represented by block 110 in FIG. 1; (b) determine, based at least partially on the transaction information, that the transaction has triggered a fraud rule 308D, as represented by block 120; (c) prompt the holder 302, via the mobile device 340 and based at least partially on making the fraud rule determination, to consent to the transaction, as represented by block 140; (d) receive, via the user interface 349 of the mobile device 340, the holder's consent to the transaction, as represented by block 140; and (e) authorize the transaction based at least partially on receiving the holder's consent, as represented by block 150. In accordance with some embodiments, the transaction machine 320, the authorization apparatus 330, and/or the mobile device 340 are each configured to send and/or receive one or more instructions to and/or from each other, such that an instruction sent, for example, from the authorization apparatus 330 to the mobile device 340 (and/or vice versa) can trigger the mobile device 340 (and/or vice versa) to perform one or more portions of any one or more of the embodiments described and/or contemplated herein.

Referring now to FIG. 4, a mixed block and flow diagram of a system 400 for providing a fraud messaging service using a fraud passcode and a mobile phone is provided, in accordance with an exemplary embodiment of the present invention. It will be understood that the system 400 represents an example embodiment of an apparatus configured to perform the process flow 200 described in connection with FIG. 2. As shown, the system 400 includes a POS device 401 (e.g., the transaction machine 320, a merchant terminal, etc.), an authorization server 403 (e.g., the authorization apparatus 330), and a mobile phone 405 (e.g., the mobile device 340). The POS device 401, the authorization server 403, and the mobile phone 405 may each include a communication interface, a user interface, a processor, a memory, an application, and/or a datastore, and those components may be operatively connected to each other.

In accordance with some embodiments, the POS device 401 and the mobile phone 405 are operatively and selectively connected to the authorization server 403 via one or more networks (not shown). For example, in some embodiments, the POS device 401 is operatively connected to the authorization server 403 via a payment network, and/or the mobile phone 405 is operatively connected to the authorization server 403 via a telephone network. Also, in this example embodiment, the POS device 401 is maintained by a merchant, the mobile phone 405 is maintained by an account holder who is a customer of a financial institution, and the authorization server 403 is maintained by that financial institution. In addition, the financial institution maintains the checking account held by the holder and associated with the debit card mentioned below. Still further, in this example embodiment, the checking account is associated with a primary passcode and a fraud passcode. In some embodiments, these passcodes were selected by the holder, or assigned to the account and/or the holder, before the transaction referred to in FIG. 4 was initiated.

As represented by block 402, the holder swipes a debit card associated with the holder's checking account at the POS device 401 and inputs the primary passcode associated with the account into the POS device 401 to engage in a debit card transaction involving the merchant. Although not shown, the POS device 401 may also authenticate the holder based at least partially on one or more credentials the customer provides to the POS device 401 (e.g., based on the debit card swiped, primary passcode, government-issued identification, etc.). Next, as represented by block 404, the POS device 401 generates and sends an authorization request associated with the debit card transaction to the authorization server 403. In accordance with some embodiments, the authorization request includes information that, for example, identifies the primary passcode, the checking account associated with the debit card, the amount of the transaction, the one or more goods and/or services involved in the transaction, the merchant, the date/time of the transaction, the location of the transaction, and/or the like. The authorization server 403 then reviews the authorization request and, in this example embodiment, determines that the transaction may involve misappropriation because the transaction amount of the transaction exceeds a predetermined amount, as represented by block 406. For example, in some embodiments, the holder may have set a transaction amount threshold of $600 when enrolling in the fraud messaging service, such that a fraud rule associated with the holder's account will be triggered if the transaction amount of any transaction involving the holder's account exceeds $600.

In this example embodiment, after making the fraud rule determination, the authorization server 403 declines the authorization request, as represented by block 408. Also, as represented by block 410, the authorization server 403 determines that the account is enrolled in a fraud messaging service provided by the financial institution. Thereafter, as represented by block 412, the authorization server 403 identifies a phone number associated with the checking account by, for example, accessing an account datastore and/or account profile having information associated with the checking account (e.g., the phone number) stored therein. In some embodiments, the holder provides the financial institution with his phone number (e.g., the phone number of the mobile phone 405) when the holder enrolls in the fraud messaging service.

After the authorization server 403 identifies the phone number, the authorization server 403 sends a fraud alert text message (e.g., SMS message, MMS message, EMS message, etc.) to the phone number, which corresponds to the holder's mobile phone 405, as represented by block 414. In accordance with some embodiments, the text message: (a) describes the transaction that triggered the fraud rule (and/or why the transaction triggered the fraud rule); and (b) prompts the holder to consent to the transaction by providing the fraud passcode associated with the account. In some embodiments, the text message received by the mobile phone 405 is delivered visually to the holder via a display of the mobile phone 405. After reading the text message at the mobile phone 405, the holder sends, via a second text message, the fraud passcode back to the authorization server 403, as represented by block 416. For example, in some embodiments, where the holder's fraud passcode is “###$,” the holder inputs “###$” into a new SMS message and then sends that SMS message to a phone number associated with the financial institution and/or the server 403. In some embodiments, by providing the fraud passcode to the server 403, the customer consents to the transaction (e.g., agrees to complete the transaction, asserts that the holder is participating in the transaction, etc.).

After receiving the fraud passcode from the holder, the authorization server 403 is configured to determine whether the fraud passcode sent matches the fraud passcode previously stored in the holder's account profile and/or previously associated with the holder's account, as represented by block 418. If the server 403 determines that the fraud passcodes match, the server 403 is configured to send another text message to the holder's mobile phone 405, where the text message prompts the holder to re-swipe the debit card at the POS device 401 to complete the transaction, as represented by block 420. Thereafter, as represented by block 422, the holder re-swipes the debit card at the POS device 401 (and/or re-inputs the primary passcode), as represented by block 422. In some embodiments, the holder consents to the transaction by re-swiping the debit card (and/or re-inputting the primary passcode).

After the customer re-swipes the debit card (and/or re-inputs the primary passcode), the POS device 401 generates and sends another authorization request to the authorization server 403, as represented by block 424, which is approved by the authorization server 403, as represented by block 426. In some embodiments, the authorization server 403 approves the second authorization request based at least partially on receiving the holder's fraud passcode and/or based at least partially on the holder re-swiping his debit card at the POS device 401. After the second authorization request has been approved, the transaction is completed at the POS device 401, as represented by block 428. It will be understood that, in some embodiments, the first authorization request, as represented by block 404, represents the first attempt to complete the transaction referred to in block 402, and the second authorization request, as represented by block 424, represents a second attempt to complete the same transaction.

Of course, it will be understood that, in this example embodiment, the person that engaged in the transaction at the POS device 401 was actually the holder of the account and not an unauthorized user. This was verified by the server 403 when the server 403 received the holder's fraud passcode from the holder's mobile phone 405. However, in some alternative embodiments, if the holder does recognize the transaction described in the first text message referred to in block 414, the holder can decline the transaction by not providing the fraud passcode, not responding to that first text message within a predetermined period of time (e.g., 60 seconds), or by affirmatively indicating, via a return text message, that the holder is not the one engaging in the transaction and/or does not authorize the transaction. Thereafter, in such alternative embodiments, the server 403 can decline the transaction and/or otherwise not allow the transaction to be completed.

Of course, the embodiment illustrated in FIG. 4 is merely exemplary and other embodiments may vary without departing from the scope and spirit of the present invention. For example, in some alternative embodiments, the first authorization request is not declined by the authorization server 403, the holder is not required to re-swipe the debit card at the POS device 401, and the second authorization request is never sent. Instead, after receiving the fraud passcode from the holder, the authorization server 403 is configured to approve the first authorization request referred to in block 404, and the transaction is completed at the POS device 401. As another example, in some alternative embodiments, one or more portions of the process flow being performed by the mobile phone 405 are performed instead by the POS device 401. As still another example, in some alternative embodiments of the present invention, instead of involving a debit card, a checking account, and/or a debit card transaction, the process flow shown in FIG. 4 involves a credit card, a credit card account, and/or a credit card transaction.

As yet another example, in some alternative embodiments, the holder is prompted to input the fraud passcode into the POS device 401 (e.g., using a keypad of the POS device 401) instead of into the mobile phone 405. In some of these embodiments, the customer receives that fraud passcode in the initial text message sent to the mobile phone 405 referred to in block 414. In some of these embodiments, the holder does not know the identity of the fraud passcode before the text message is sent (e.g., the server 403 dynamically generates the fraud passcode after determining that the fraud rule has been triggered). As such, in some embodiments, the holder is sent a one-time and/or dynamically-generated fraud passcode via the mobile phone 405, and the holder then inputs that fraud passcode into the POS device 401 to complete the transaction. In some embodiments, the provision of the fraud passcode serves to verify, to the financial institution and/or to the server 403, that the person engaging in the transaction is likely the account holder because the person engaging in the transaction also has access to the holder's mobile phone 405.

As another example, in some alternative embodiments, the holder is prompted, via the POS device 401, to input the fraud passcode into the mobile phone 405 (e.g., the holder is prompted to send a text message to the financial institution from the mobile phone 405, input the fraud passcode into a mobile banking application that executes on the mobile phone 405, etc.). As still another example, instead of involving the mobile phone 405 at all, the server 403 prompts the holder, via the POS device 401, to input the fraud passcode into the POS device 401. However, it will be understood that the involvement of the mobile phone 405 in the process flow shown in FIG. 4 provides the server 403 and/or financial institution with additional assurances that the real holder has consented to the transaction (e.g., because the holder—and not a dishonest individual—is most likely to be in possession of the holder's mobile phone 405 and/or know the holder's fraud passcode).

In some embodiments, one or more of the portions of the process flow represented by blocks 402-428 are triggered by one or more triggering events, which, in some embodiments, include the performance of one or more of the other portions of the process flow represented by blocks 402-428. Also, in some embodiments, the system 400 is configured to perform the entire process flow represented by blocks 402-428, from start to finish, within moments, seconds, and/or minutes. For example, in some embodiments, the customer inputs the fraud PIN into the POS device 401 within approximately 1-5 minutes of the authorization server 403 receiving the authorization request from the POS device 401.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A computer-implemented method comprising:
providing a non-transitory computer-readable medium comprising computer program code stored thereon, wherein said computer program code is specifically configured to cause one or more computer processing devices to perform the following operations when performing the computer program code:
receiving transaction information associated with a pending transaction, wherein the pending transaction involves an account, and wherein the account is held by an account holder;
comparing one or more predetermined aspects of the received transaction information to at least one fraud rule, wherein the at least one fraud rule, if met, indicates that the pending transaction may involve fraud;
determining, based at least partially on the transaction information, that the transaction has triggered the at least one fraud rule;
thereafter, prompting, via a mobile device, the holder to consent to the pending transaction, wherein the mobile device is associated with the holder, and wherein the prompting is based at least partially on the determining;
receiving the holder's consent to the pending transaction; and
authorizing the pending transaction based at least partially on the receiving the holder's consent.

2. The method of claim 1, further comprising computer program code is specifically configured to cause one or more computer processing devices to perform the following operations when performing the computer program code:
receiving second transaction information associated with a second transaction, wherein the second transaction involves the account;
determining, based at least partially on the second transaction information, that the second transaction has triggered a second fraud rule;
prompting, via the mobile device, the holder to consent to the second transaction, wherein the prompting the holder to consent to the second transaction is based at least partially on the determining that the second transaction has triggered the second fraud rule;
receiving information indicating that the holder has not consented to the second transaction; and
declining the second transaction based at least partially on the receiving the information.

3. The method of claim 2, wherein the receiving the information indicating that the holder has not consented comprises receiving a message from the holder indicating that the holder does not consent to the second transaction.

4. The method of claim 2, wherein the receiving the information indicating that the holder has not consented comprises receiving a message indicating that the holder has not responded to the prompting associated with the second transaction within a predetermined period of time.

5. The method of claim 1, wherein the transaction involves a merchant and comprises a transaction amount, and wherein the prompting comprises sending a message to the holder that identifies the merchant and transaction amount.

6. The method of claim 1, wherein the account is associated with a passcode, wherein the receiving holder's consent comprises receiving the passcode, and wherein the authorizing is based at least partially on the receiving the passcode.

7. The method of claim 6, wherein the prompting the holder to consent to the transaction comprises prompting the holder to provide the passcode.

8. The method of claim 1, wherein the transaction information comprises a primary passcode associated with the account, and wherein the receiving the holder's consent comprises receiving a fraud passcode associated with the account, wherein the fraud passcode is different than the primary passcode.

9. The method of claim 1, the method further comprising computer program code is specifically configured to cause one or more computer processing devices to perform the following operations when performing the computer program code:
declining the transaction based at least partially on the determining that the transaction has triggered the fraud rule, and
wherein the receiving the holder's consent and the authorizing the transaction both occur after the declining the transaction.

10. The method of claim 1, wherein the receiving the holder's consent comprises receiving the holder's consent via the mobile device.

11. The method of claim 1, wherein the transaction involves a transaction machine, and wherein the receiving the holder's consent comprises receiving the holder's consent via the transaction machine.

12. The method of claim 1, wherein the determining that the transaction has triggered a fraud rule comprises determining that the transaction involves a merchant from a predetermined group of merchants.

13. The method of claim 1, wherein the determining that the transaction has triggered a fraud rule comprises determining that the transaction comprises a transaction amount that is greater than a predetermined amount.

14. The method of claim 1, wherein the determining that the transaction has triggered a fraud rule comprises determining that the transaction involves a merchant category code from a predetermined group of merchant category codes.

15. The method of claim 1, wherein the determining that the transaction has triggered a fraud rule comprises determining that the transaction has occurred outside of a predetermined geographic area.

16. The method of claim 1, wherein the determining that the transaction has triggered a fraud rule comprises determining that the transaction involves a product from a predetermined group of products.

17. The method of claim 1, wherein the determining that the transaction has triggered a fraud rule comprises determining that the transaction occurred within a predetermined period of time after a previous transaction involving the account occurred.

18. The method of claim 1,
wherein the transaction involves a transaction machine,
wherein the prompting the holder to consent to the transaction comprises sending a passcode to the mobile device,
wherein the receiving the holder's consent comprises receiving the passcode via the transaction machine, and
wherein the authorizing the transaction is based at least partially on receiving the passcode via the transaction machine.

19. The method of claim 1, wherein the passcode is not known to the holder before the passcode is sent to the holder.

20. An apparatus comprising:
a processing device configured to:
receive, via a payment network, transaction information associated with a pending transaction, wherein the pending transaction involves an account, and wherein the account is held by an account holder;
compare one or more predetermined aspects of the received transaction information to at least one fraud rule, wherein the at least one fraud rule, if met, indicates that the pending transaction may involve fraud;
determine, based at least partially on the transaction information, that the transaction has triggered the at least one fraud rule;
thereafter, prompt, via a mobile device, the holder to consent to the transaction, wherein the mobile device is associated with the holder, and wherein the prompting is based at least partially on the determining;
receive the holder's consent to the pending transaction; and
authorize the pending transaction based at least partially on the receiving the holder's consent.

21. The apparatus of claim 20, wherein the processor is further configured to:
receive second transaction information associated with a second transaction, wherein the second transaction involves the account;
determine, based at least partially on the second transaction information, that the second transaction has triggered a second fraud rule;
prompt, via the mobile device, the holder to consent to the second transaction, wherein the prompting the holder to consent to the second transaction is based at least partially on the determining that the second transaction has triggered the second fraud rule;
receive information indicating that the holder has not consented to the second transaction; and
decline the second transaction based at least partially on the receiving the information.

22. The apparatus of claim 21, wherein the processing device receives the information indicating that the holder has not consented by receiving a message from the holder indicating that the holder does not consent to the second transaction.

23. The apparatus of claim 21, wherein the processing device receives the information indicating that the holder has not consented by receiving a message indicating that the holder has not responded to the prompting associated with the second transaction within a predetermined period of time.

24. The apparatus of claim 20, wherein the account is associated with a passcode, wherein the processing device receives the holder's consent by receiving the passcode, and wherein the processing device authorizes the transaction based at least partially on the receiving the passcode.

25. The apparatus of claim 24, wherein the processing device prompts the holder to consent to the transaction by prompting the holder to provide the passcode.

26. The apparatus of claim 20, wherein the transaction information comprises a primary passcode associated with the account, and wherein the processing device receives the holder's consent by receiving a fraud passcode associated with the account, wherein the fraud passcode is different than the primary passcode.

27. The apparatus of claim 20, wherein the processing device is further configured to:
decline the transaction based at least partially on the determining that the transaction has triggered the fraud rule, and
wherein the processing device receives the holder's consent and authorizes the transaction after the declining the transaction.

28. The apparatus of claim 20, wherein the processing device receives the holder's consent based at least partially on the holder inputting information into the mobile device.

29. The apparatus of claim 20, wherein the transaction involves a transaction machine, and wherein the processing device receives the holder's consent based at least partially on the holder inputting information into the transaction machine.

30. The apparatus of claim 20, wherein the processing device determines that the transaction has triggered a fraud rule by determining that the transaction involves a merchant from a predetermined group of merchants.

31. The apparatus of claim 20, wherein the processing device determines that the transaction has triggered a fraud rule by determining that the transaction comprises a transaction amount that is greater than a predetermined amount.

32. The apparatus of claim 20, wherein the processing device determines that the transaction has triggered a fraud rule by determining that the transaction has occurred outside of a predetermined geographic area.

33. The apparatus of claim 20, wherein the processing device determines that the transaction has triggered a fraud rule by determining that the transaction occurred within a predetermined period of time after a previous transaction involving the account occurred.

34. The apparatus of claim 20,
wherein the transaction involves a transaction machine,
wherein the processing device prompts the holder to consent to the transaction by sending a passcode to the mobile device,
wherein the processing device receives the holder's consent by receiving the passcode via the transaction machine, and
wherein the processing device authorizes the transaction based at least partially on receiving the passcode via the transaction machine.

35. The apparatus of claim 20, wherein the passcode is not known to the holder before the passcode is sent to the holder.

36. A computer program product comprising a non-transitory computer-readable medium, wherein the non-transitory computer-readable medium comprises one or more computer-executable program code portions that, when executed by a computer, cause the computer to:
receive transaction information associated with a transaction, wherein the transaction involves an account, and wherein the account is held by an account holder;
determine that the transaction may be fraudulent;
prompt, via a mobile device, the holder to consent to the transaction, wherein the mobile device is associated with the holder;
determine that the holder has not consented to the transaction within a predetermined period of time; and
decline the transaction based at least partially on the computer determining that the holder has not consented within the predetermined period of time.

37. The computer program product of claim 36, wherein the one or more computer-executable program code portions, when executed by the computer, cause the computer to: receive a message from the holder within a predetermined period of time, wherein the message indicates that the holder does not consent to the transaction; and
determine that the holder has not consented within the predetermined period of time based at least partially the computer receiving the message.

38. The computer program product of claim 36, wherein the one or more computer-executable program code portions, when executed by the computer, cause the computer to:
prompt the holder to consent to the transaction by prompting the holder to provide a passcode associated with the account.

39. The computer program product of claim 36, wherein the one or more computer-executable program code portions, when executed by the computer, cause the computer to:
determine that the transaction may be fraudulent by determining that the transaction involves a merchant from a predetermined group of merchants.

40. The computer program product of claim 36, wherein the one or more computer-executable program code portions, when executed by the computer, cause the computer to:
determine that the transaction may be fraudulent by determining that the transaction comprises a transaction amount that is greater than a predetermined amount.

41. The computer program product of claim 36, wherein the one or more computer-executable program code portions, when executed by the computer, cause the computer to:
determine that the transaction may be fraudulent by determining that the transaction has occurred outside of a predetermined geographic area.

42. The computer program product of claim 36, wherein the one or more computer-executable program code portions, when executed by the computer, cause the computer to:
determine that the transaction may be fraudulent by determining that the transaction occurred within a predetermined period of time after a previous transaction involving the account occurred.

43. A method comprising:
receiving transaction information associated with a transaction, wherein the transaction involves an account and a transaction machine, and wherein the account is held by an account holder;
determining, based at least partially on the transaction information, that the transaction has triggered a fraud rule;
prompting, via the transaction machine, the holder to consent to the transaction, wherein the prompting is based at least partially on the determining;
receiving the holder's consent to the transaction via a mobile device associated with the holder; and
authorizing the transaction based at least partially on the receiving the holder's consent via the mobile device associated with the holder.

44. The method of claim 43,
wherein the prompting the holder to consent to the transaction comprises sending a message to the transaction machine, wherein the message prompts the holder to input a passcode associated with the account into the mobile device,
wherein the receiving the holder's consent comprises receiving the passcode, wherein the receiving the passcode is based at least partially on the holder inputting the passcode into the mobile device, and
wherein the authorizing the transaction is based at least partially on the receiving the passcode via the mobile device.

45. The method of claim 44, wherein the passcode was selected by the holder before the transaction was initiated.

46. The method of claim 43, further comprising:
receiving second transaction information associated with a second transaction, wherein the second transaction involves a second account and a second transaction machine, and wherein the second account is held by a second holder;
determining, based at least partially on the second transaction information, that the second transaction has triggered a second fraud rule;
prompting, via the second transaction machine, the second holder to consent to the second transaction, wherein the prompting the second holder is based at least partially on the determining that the second transaction has triggered the second fraud rule;
determining that the second holder has not consented to the second transaction; and
declining the second transaction based at least partially on the determining that the second holder has not consented.

47. The method of claim 46, wherein the determining that the second holder has not consented comprises receiving a message from the second holder indicating that the second holder does not consent to the second transaction.

48. The method of claim 46, wherein the determining that the second holder has not consented comprises determining that the second holder has not responded to the prompting associated with the second transaction within a predetermined period of time.

49. The method of claim 43, the method further comprising:
declining the transaction based at least partially on the determining that the transaction has triggered the fraud rule, and
wherein the receiving the holder's consent and the authorizing the transaction both occur after the declining the transaction.

50. The method of claim 43, wherein the determining that the transaction has triggered a fraud rule comprises determining that the transaction comprises a transaction amount that is greater than a predetermined amount.

51. The method of claim 43, wherein the determining that the transaction has triggered a fraud rule comprises determining that the transaction occurred within a predetermined period of time after a previous transaction involving the account occurred.

52. The method of claim 43,
wherein the prompting the holder to consent to the transaction comprises sending a passcode to the transaction machine,
wherein the receiving the holder's consent comprises receiving the passcode via the mobile device, and
wherein the authorizing the transaction is based at least partially on receiving the passcode via the mobile device.

53. The method of claim 52, wherein the passcode is not known to the holder before the passcode is sent to the holder.
